(19) United States
(12) Patent Application Publication
(10) Pub. No.: US 2026/0066477 A1
(43) Pub. Date: Mar. 5, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(72) Inventors: Kotaro TAKADA, Osaka (JP); Osamu NAKAYAMA, Osaka (JP); Katsushi MIYAZAKI, Osaka (JP); Daiki TSUJI, Osaka (JP); Takami IZAWA, Kanagawa (JP); Masayuki NAKAI, Kanagawa (JP); Yasuhiro YANAGIHARA, Kanagawa (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(21) Appl. No.: 19/117,754

(22) PCT Filed: Oct. 4, 2023
(86) PCT No.: PCT/JP2023/036205

§ 371 Date: Apr. 2, 2025

(30) Foreign Application Priority Data
Oct. 6, 2022 (JP) 2022-161746

(51) Int. Cl. H01M 50/503; H01M 50/298

(52) U.S. Cl. CPC H01M 50/503; H01M 50/298

(57) ABSTRACT

A wiring module is to be coupled to a battery stack member including power storage elements that have electrode terminals and are stacked. The wiring module includes an electric wire and a protector including an electric wire housing portion that has a groove shape extending in a first direction and in which the electric wire is arranged. The electric wire housing portion includes a bottom wall, a pair of side walls that extend upward from two side edges of the bottom wall and that are opposite each other in a second direction that is perpendicular to the first direction, and at least one stopper piece that extends from one of the pair of side walls toward other one of the pair of side walls and with which the electric wire is less likely to be out of the electric wire housing portion.

### TECHNICAL FIELD

The present disclosure relates to a wiring module.

### BACKGROUND ART

A high-pressure battery pack that is used in an electric automobile or a hybrid automobile normally includes battery cells that are disposed on top of each other and are electrically connected in series or in parallel to each other with a wiring module. A battery wiring module that is disclosed in Japanese Unexamined Patent Application Publication No. 2013-16382 (Patent Document 1 described below) has been known as an example of such a wiring module. The battery wiring module described in Patent Document 1 includes connection members connecting electrode terminals of single cells, voltage detection terminals connected to the connection members, wires connected to the voltage detection terminals, and a housing member made of synthetic resin and receiving the connection members, the voltage detection terminals, and the wires. The wires extend in a wire insertion portion that is a groove formed in the housing member. Tabs are provided on the wire insertion portion for holding the wires in the wire insertion portion.

### PRIOR ART

### Patent Document

Patent Document 1: Japanese Unexamined Patent Application Publication No. 2013-16382

### SUMMARY OF THE INVENTION

### Problem to be Solved by the Invention

In the configuration described above, the wires extend in the wire insertion portion, which opens upward, and are held by a pair of tabs from above. However, since the tabs are small with respect to the wire insertion portion, the wires may be out of the wire insertion portion through the opening, particularly, from a portion of the wire insertion portion that is not covered by the tabs. The wires that are out of the wire insertion portion may be damaged when the casing is attached to the battery wiring module, for instance.

### Means for Solving the Problem

A wiring module according to the present disclosure is to be coupled to a battery stack member including power storage elements that have electrode terminals and are stacked. The wiring module includes an electric wire and a protector including an electric wire housing portion that has a groove shape extending in a first direction and in which the electric wire is arranged. The electric wire housing portion includes a bottom wall, a pair of side walls that extend upward from two side edges of the bottom wall and that are opposite each other in a second direction that is perpendicular to the first direction, and at least one stopper piece that extends from one of the pair of side walls toward other one of the pair of side walls and with which the electric wire is less likely to be out of the electric wire housing portion. The stopper piece includes a basal end portion that is connected to the one of the pair of side walls and a distal end portion that is close to the other one of the pair of side walls, and a dimension of the basal end portion with respect to the first direction is greater than a dimension of the electric wire housing portion with respect to the second direction.

### Effects of the Invention

According to the present disclosure, a wiring module in which a wire is less likely to be out of an electric wire housing portion can be provided.

### BRIEF DESCRIPTION OF THE DRAWINGS

FIG. 1 is a front view of a wiring module according to an embodiment.

FIG. 2 is a cross-sectional view along A-A line in FIG. 2.

FIG. 3 is an enlarged perspective view of a portion of a protector including an electric wire housing portion.

FIG. 4 is a perspective view of a front portion of a battery stack member.

FIG. 5 is a perspective view illustrating a portion of a laminated type battery.

### MODES FOR CARRYING OUT THE INVENTION

### Description of Embodiments According to the Present Disclosure

First, embodiments according to the present disclosure will be listed and described.

(1) A wiring module according to the present disclosure is to be coupled to a battery stack member including power storage elements that have electrode terminals and are stacked. The wiring module includes an electric wire and a protector including an electric wire housing portion that has a groove shape extending in a first direction and in which the electric wire is arranged. The electric wire housing portion includes a bottom wall, a pair of side walls that extend upward from two side edges of the bottom wall and that are opposite each other in a second direction that is perpendicular to the first direction, and at least one stopper piece that extends from one of the pair of side walls toward other one of the pair of side walls and with which the electric wire is less likely to be out of the electric wire housing portion. The stopper piece includes a basal end portion that is connected to the one of the pair of side walls and a distal end portion that is close to the other one of the pair of side walls, and a dimension of the basal end portion with respect to the first direction is greater than a dimension of the electric wire housing portion with respect to the second direction.

According to such a configuration, with the basal end portion being long in the first direction, the electric wire can be surely held by the stopper piece.

(2) A largest dimension of the stopper piece with respect to the second direction is preferably greater than a half of the dimension of the electric wire housing portion with respect to the second direction.

According to such a configuration, with the stopper piece being long in the second direction, the electric wire can be held by the stopper piece more surely.

(3) A dimension of the stopper piece with respect to the first direction preferably decreases as the stopper piece extends from the basal end portion toward the distal end portion.

According to such a configuration, the electric wire can be easily arranged in the electric wire housing portion.

(4) A smallest dimension of a space between the distal end portion and the other one of the pair of side walls is preferably smaller than an outer diameter of the electric wire.

According to such a configuration, the electric wire is less likely to be out of the electric wire housing portion.

(5) The other one of the pair of side walls preferably includes an opposing portion that is opposite the distal end portion and a recess portion that is recessed from the opposing portion toward the bottom wall.

According to such a configuration, with the recess portion, the electric wire can be easily arranged in the electric wire housing portion.

(6) The electric wire housing portion preferably includes stopper pieces including the at least one stopper piece. The pair of side walls preferably include a first side wall and a second side wall. The stopper pieces preferably include first stopper pieces extending from the first side wall and second stopper pieces extending from the second side wall.

According to such a configuration, with the first stopper pieces extending from the first side wall and the second stopper pieces extending from the second side wall being provided, the electric wire is further less likely to be out of the electric wire housing portion.

(7) The first stopper pieces and the second stopper pieces are preferably arranged alternately in the first direction.

According to such a configuration, the first stopper pieces and the second stopper pieces are arranged alternately. Therefore, the electric wire is further less likely to be out of the electric wire housing portion.

### Details of Embodiments According to the Present Disclosure

Embodiments according to the present disclosure will be described. The present disclosure is not limited to the embodiments. All modifications within and equivalent to the technical scope of the claimed invention may be included in the technical scope of the present invention.

### Embodiment

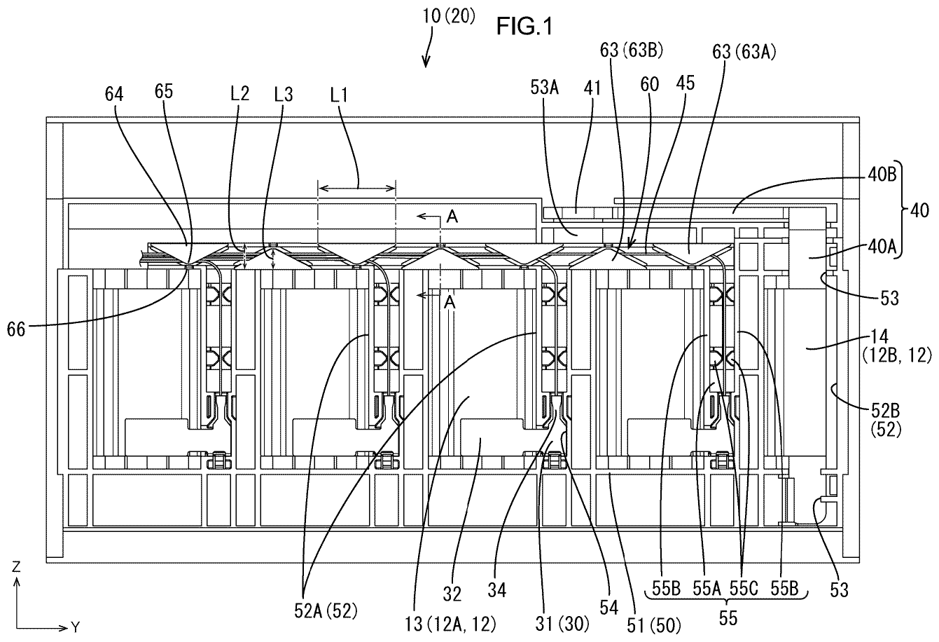

An embodiment of the present disclosure will be described with reference to FIGS. 1 to 5. A power storage module 10 including a wiring module 20 according to this embodiment is installed in a vehicle as a power source for driving a vehicle such as an electric automobile or a hybrid automobile. In the following description, regarding components having the same configuration, some of the components may be indicated by reference signs and others may not be indicated by the reference signs. In the following description, it is considered that an X arrow, a Y arrow, and an Z arrow point the front side, the left side, and the upper side, respectively. In this embodiment, a right-left direction is one example of a first direction and an upper-bottom direction is one example of a second direction.

### Battery Stack Member

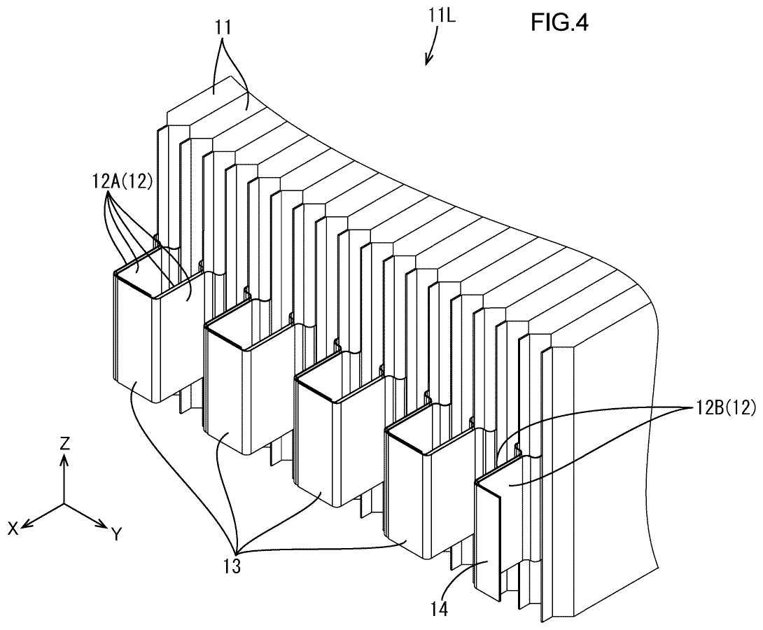

The power storage module 10 includes a battery stack member 11L illustrated in FIG. 4 and the wiring module 20 that is attached to the battery stack member 11L as illustrated in FIG. 1.

### Laminated Type Battery, Electrode Lead

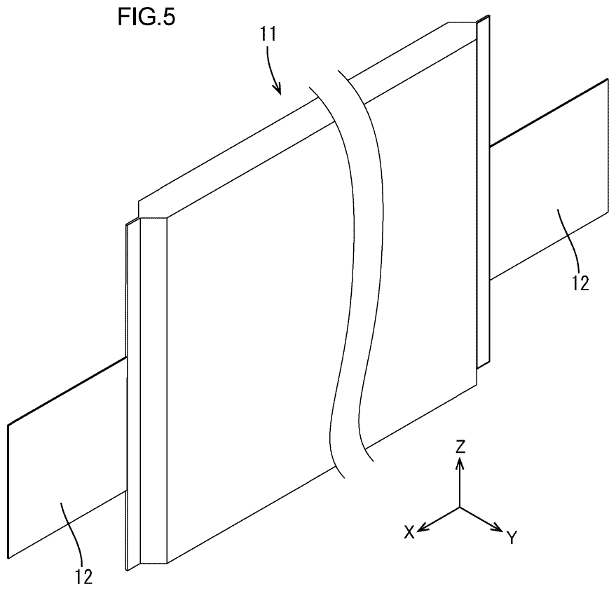

As illustrated in FIG. 4, the battery stack member 11L includes laminated type batteries 11 (one example of a power storage element) (eighteen laminated type batteries in this embodiment) that are stacked in a stacking direction (the right-left direction). Only a front portion of the battery stack member 11L is illustrated in FIG. 4. As illustrated in FIG. 5, the laminated type batteries 11 have a flat shape that is elongated in a front-rear direction and has a small thickness in the right-left direction. The laminated type batteries 11 include power storage components (not illustrated) therein. The laminated type battery 11 includes a pair of electrode leads 12 (one example of an electrode terminal). The pair of electrode leads 12 are on front and rear sides of the laminated type battery 11, respectively, and protrude from the laminated type battery 11 in opposite directions. The pair of electrode leads 12 have a plate shape and have opposite polarities.

As illustrated in FIG. 4, the battery stack member 11L includes connection portions 13 where the four electrode leads 12 of the adjacent laminated type batteries 11 that are arranged in the right-left direction are electrically connected. The four electrode leads 12 are bent leftward or rightward at a right angle and overlapped and connected with laser welding and thus, the connection portions 13 are formed. Some of the electrode leads 12 are configured as the connection portions 13 and are defined as connection electrode leads 12A. Among the four connection electrode leads 12A, the two connection electrode leads 12A on the right side and the two connection electrode leads 12A on the left side have opposite polarities. For example, the two connection electrode leads 12A on the right side have a positive polarity and the two connection electrode leads 12A on the left side have a negative polarity. Therefore, in the battery stack member 11L, the two laminated type batteries 11 that are connected in parallel are connected series via the connection portion 13. The battery stack member 11L includes four connection portions 13 on a front section. The battery stack member 11L includes four connection portions 13 on a rear section, although it is not illustrated.

The battery stack member 11L includes an output portion 14 on a left edge portion of a front section. The battery stack member 11L also includes the output portion 14 on a right edge portion of the front section, although it is not illustrated. Among the electrode leads 12, the two electrode leads 12, which are not configured as the connection portion 13, are connected and configured as the output portion 14. The electrode leads 12 that are configured as the output portion 14 are defined as output electrode leads 12B. The two output electrode leads 12B that are configured as the output portion 14 have a same polarity. The output portion 14 is configured as a positive polarity or a negative polarity of the whole battery stack member 11L. Namely, with the output portion 14 on the front section having a positive polarity of the whole battery stack member 11L, the output portion 14 on the rear section has a negative polarity of the whole battery stack member 11L.

### Wiring Module

As illustrated in FIG. 1, the wiring module 20 of this embodiment includes terminals 30 that are connected to the connection electrode leads 12A, a busbar 40 that is connected to the output electrode leads 12B, electric wires 45 that are connected to the terminals 30, and a protector 50 that holds the terminals 30, the busbar 40, and the electric wires 45. In the following, a configuration of the wiring module 20 that is arranged on a front side of the power storage module 10 will be described in detail. The wiring module 20 arranged on a rear side of the power storage module 10, which is not illustrated, has a configuration similar to that of the wiring module 20 arranged on the front side of the power storage module 10.

The busbar 40 has a plate shape and is made by processing a metal plate having electrically conductive properties. As illustrated in FIG. 1, the busbar 40 includes a first portion 40A that extends in the upper-bottom direction and a second portion 40B that is connected to an upper end portion of the first portion 40A. The first portion 40A has a flat shape having a small thickness in the front-rear direction. The second portion 40B extends rightward from the upper end portion of the first portion 40A and has a flat shape having a small thickness in the upper-bottom direction. The busbar 40 is held in a busbar holding portion 53 of the protector 50 and a middle portion of the first portion 40A in the upper-bottom direction is connected to the output electrode lead 12B. A busbar side connection portion 41 is at a right end portion of the second portion 40B.

The busbar side connection portion 41 has a through hole (which is not illustrated) through which a bolt is inserted. An external connection terminal (not illustrated) is disposed on the busbar side connection portion 41 and fixed to the busbar side connection portion 41 with the bolt. Accordingly, the busbar side connection portion 41 is electrically connected to the external connection terminal. The external connection terminal is used for connecting the power storage module 10 and an external device, which is not illustrated.

The terminal 30 is formed by processing an electrically conductive metal plate. As illustrated in FIG. 1, the terminal 30 includes a body portion 31, a connection portion 32 extending rightward from the body portion 31, and a wire connection portion 34 extending upward from the body portion 31. The body portion 31 is arranged and held in a terminal housing portion 54 of the protector 50. The connection portion 32 is configured to be surface-contacted with a portion of the connection portion 13 or a portion of the connection electrode lead 12A that is configured as the connection portion 13. Namely, the terminal 30 is not for connecting the adjacent connection electrode leads 12A but for connecting the connection electrode leads 12A that are previously connected (the connection portion 13) and the electric wire 45. The wire connection portion 34 includes a crimp portion that is crimped onto the electric wire 45.

### Electric Wire

One end of each electric wire 45 is connected to the terminal 30. Other ends of the electric wires 45, which are not illustrated in FIG. 1, are connected to an ECU (electric control unit) via a connector. The ECU has a known configuration including a microcomputer and components and has a function of detecting a voltage, a current, and a temperature of each laminated type battery 11 and has a function of controlling charging and discharging of each laminated type battery 11. Namely, the electric wires 45 are so-called voltage detection wires. The electric wires 45 are arranged in an electric wire housing portion 60 and branch routing portions 55.

### Protector

The protector 50 is made of synthetic resin having insulating properties and has a plate shape. As illustrated in FIG. 1, the protector 50 includes a protector body 51 that is positioned with respect to the battery stack member 11L. Electrode housing recess portions 52 are arranged in the right-left direction and are in a middle of the protector body 51 with respect to the upper-bottom direction. The electrode housing recess portions 52 are through in the front-rear direction and have an elongated rectangular shape extending in the upper-bottom direction. The electrode housing recess portions 52 include connection electrode housing recess portions 52A that receive the connection portions 13 and the connection electrode leads 12A and an output electrode housing recess portion 52B that receives the output electrode lead 12B and the output portion 14.

The output electrode housing recess portion 52B includes busbar holding portions 53, which hold the busbar 40, on upper and lower portions thereof. A bolt fixing portion 53A for fixing the busbar 40 with a screw is on a right side of the upper busbar holding portion 53. The terminal housing portion 54 in which a portion of the terminal 30 is arranged is on an obliquely lower left side of the connection electrode housing recess portion 52A.

The branch routing portion 55 is on a right side of the connection electrode housing recess portion 52A. The branch routing portion 55 is recessed rearward from the protector body 51. The branch routing portion 55 is a groove extending in the upper-bottom direction. The branch routing portion 55 includes a groove bottom wall 55A, a pair of groove side walls 55B, and a pair of stopper protrusions 55C. The groove side walls 55B extend frontward from two side edges of the groove bottom wall 55A with respect to the right-left direction. The stopper protrusions 55C extend from front end portions of the groove side walls 55B so as to become closer to each other. The branch routing portion 55 is connected to the terminal housing portion 54 at a lower end portion thereof. The branch routing portion 55 is connected to the electric wire housing portion 60 at an upper end portion thereof. The pair of stopper protrusions 55C hold the electric wire 45 from above such that the electric wire 45 is less likely to move out of the branch routing portion 55.

### Electric Wire Housing Portion

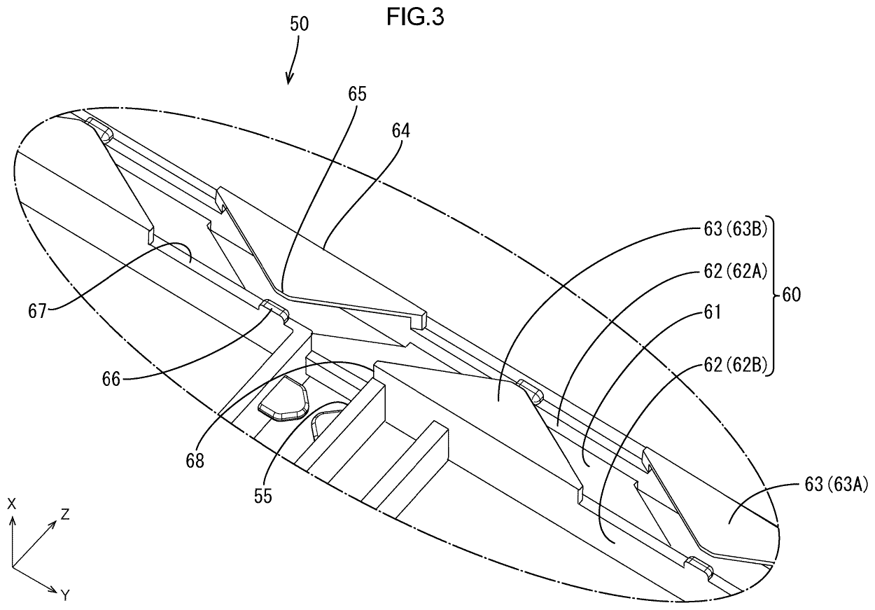

The electric wire housing portion 60 is in an upper portion of the protector 50 and is recessed rearward from the protector body 51. The electric wire housing portion 60 is a groove extending in the right-left direction. As illustrated in FIG. 3, the electric wire housing portion 60 includes a bottom wall 61, a pair of side walls 62, and stopper pieces 63. The side walls 62 extend frontward from two side edges of the bottom wall 61 with respect to the upper-bottom direction. The stopper pieces 63 extend from front end portions of the side walls 62. The pair of side walls 62 are opposite each other with respect to the upper-bottom direction. An upper one of the pair of side walls 62 is defined as a first side wall 62A and a lower one is defined as a second side wall 62B.

### Stopper Piece

The stopper piece 63 has a substantially isosceles triangle shape seen from an opening side (a front side) of the electric wire housing portion 60. The stopper pieces 63 include first stopper pieces 63A extending from the first side wall 62A and second stopper pieces 63B extending from the second side wall 62B. The first stopper pieces 63A extend from the first side wall 62A downward and toward the second side wall 62B. The second stopper pieces 63B extend from the second side wall 62B upward and toward the first side wall 62A. Namely, the stopper pieces 63 extend from one of the pair of side walls 62 toward other one of the pair of side walls 62. As illustrated in FIG. 1, the stopper pieces 63 cover the electric wire 45, which is arranged in the electric wire housing portion 60, from the front side. With the sopper pieces 63, the electric wire 45 is less likely to move out of the electric wire housing portion 60.

### Basal End Portion, Distal End Portion

As illustrated in FIG. 3, the stopper pieces 63 extending from one of the pair of side walls 62 include basal end portions 64 that are connected to the one of the pair of side walls 62 and distal end portions 65 that are close to other one of the pair of side walls 62. Specifically, the basal end portions 64 of the first stopper pieces 63A are upper portions of the first stopper pieces 63A and the distal end portions 65 of the first stopper pieces 63A are lower end portions of the first stopper pieces 63A. The basal end portions 64 of the second stopper pieces 63B are lower portions of the second stopper pieces 63B and the distal end portions 65 of the second stopper pieces 63B are upper end portions of the second stopper pieces 63B.

### Opposing Portion

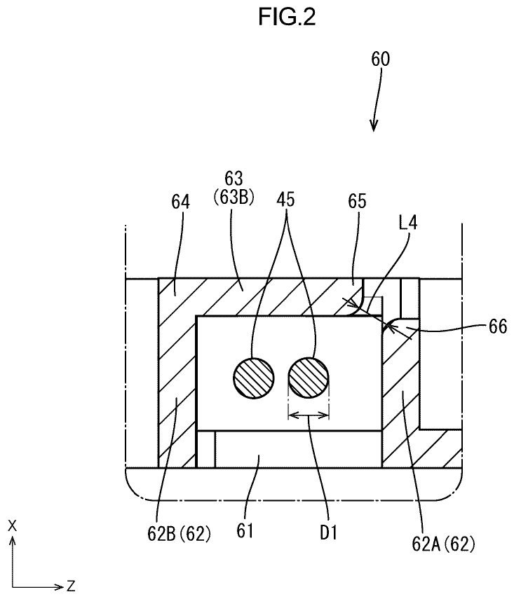

The distal end portions 65 that extend from one of the pair of side walls 62 are opposite opposing portions 66 that are on portions of other one of the pair of side walls 62 that are closest to the distal end portions 65. The opposing portions 66 are on front end portions of the side walls 62, that is, on end portions of the electric wire housing portion 60 with respect to the opening direction. As illustrated in FIG. 2, a dimension L4 (a smallest dimension between the distal end portion 65 and the side wall 62 that is opposite the distal end portion 65) between the distal end portion 65 and the opposing portion 66 is smaller than an outer diameter D1 of the electric wire 45. With such a configuration, the electric wire 45 is less likely to move out of the electric wire housing portion 60. When the electric wire 45 is put in the electric wire housing portion 60, for instance, a space between the distal end portion 65 and the opposing portion 66 is increased by bending the stopper piece 63 in the front-rear direction or bending the side wall 62 in the upper-bottom direction. Then, the electric wire 45 is inserted through the space between the distal end portion 65 and the opposing portion 66 and the electric wire 45 is arranged in the electric wire housing portion 60.

As illustrated in FIG. 1, a dimension L1 of the basal end portion 64 measured in the right-left direction is greater than a dimension L2 of the electric wire housing portion 60 measured in the upper-bottom direction. A largest dimension L3 of the stopper piece 63 measured in the upper-bottom direction (in this embodiment, a dimension from the basal end portion 64 to the distal end portion 65 measured in the upper-bottom direction) is greater than a half of the dimension L2 of the electric wire housing portion 60 measured in the upper-bottom direction. With the stopper pieces 63 being formed with such dimensions, the stopper pieces 63 are increased in size with respect to the electric wire housing portion 60 and the electric wire 45 is further less likely to be out of the electric wire housing portion 60.

The stopper piece 63 has a width in the right-left direction and becomes narrower as it extends from the basal end portion 64 toward the distal end portion 65. In other words, the dimension of the stopper piece 63 measured in the right-left direction decreases as the stopper piece 63 extends from the basal end portion 64 toward the distal end portion 65. Accordingly, an area between the distal end portion 65 and the opposing portion 66 with respect to the right-left direction is small. Therefore, the electric wire 45 can be arranged in the electric wire housing portion 60 easily.

As illustrated in FIG. 3, the electric wire housing portion 60 includes the first stopper piece 63A and the second stopper piece 63B that extend in opposite directions. Accordingly, even if the electric wire 45 is arranged closer to one any of the pair of side walls 62 in the electric wire housing portion 60, the electric wire 45 is less likely to be out of the electric wire housing portion 60 (refer to FIG. 1). In the electric wire housing portion 60, the first stopper pieces 63A and the second stopper pieces 63B are arranged alternately in the right-left direction. Therefore, the electric wire 45 is further less likely to move out of the electric wire housing portion 60.

The stopper pieces 63 become narrower with respect to the right-left direction as they extend from the basal end portions 64 toward the distal end portions 65 and the first stopper pieces 63A and the second stopper pieces 63B are arranged alternately in the right-left direction. With such a configuration, the space between the adjacent stopper pieces 63 can be smaller. As a result, the frontward opening area of the electric wire housing portion 60 can be smaller. Therefore, the electric wire 45 is much further less likely to move out of the electric wire housing portion 60.

### Recess Portion

As illustrated in FIG. 3, the side walls 62 include recess portions 67 on right and left sides of the opposing portion 66. The recess portions 67 are recessed toward the bottom wall 61 (rearward). With the recess portions 67, when the electric wire 45 is put in the electric wire housing portion 60, the electric wire 45 can be easily inserted through the spaces between the distal end portions 65 and the opposing portions 66 without bending the stopper pieces 63 largely.

The second side wall 62B includes connection portions 68 that are recessed toward the bottom wall 61 (rearward). The branch routing portions 55 are connected to the electric wire housing portion 60 via the connection portions 68. The electric wires 45 in the electric wire housing portion 60 are routed in the respective branch routing portions 55 via the connection portions 68.

### Operations and Effects of Embodiment

According to the embodiment, operations and effects described below are obtained.

The wiring module 20 according to the embodiment is to be coupled to the battery stack member 11L including power storage elements (the laminated type batteries 11) that are stacked. The power storage elements include the electrode terminals (the electrode leads 12). The wiring module 20 includes the electric wire 45 and the protector 50. The protector 50 includes the electric wire housing portion 60 that has a groove shape extending in the first direction (the right-left direction) and in which the electric wire 45 is arranged. The electric wire housing portion 60 includes the bottom wall 61, a pair of side walls 62, and at least one stopper piece 63. The pair of side walls 62 extend upward from the two side edges of the bottom wall 61. The pair of side walls 62 are opposite each other with respect to the second direction (the upper-bottom direction) that is perpendicular to the first direction. The at least one stopper piece 63 extends from one of the pair of side walls 62 toward other one of the pair of side walls 62. With the at least one stopper piece 63, the electric wire 45 is less likely to be out of the electric wire housing portion 60. The stopper piece 63 includes the basal end portion 64 that is connected to the one of the pair of side walls 62 and the distal end portion 65 that is closer to other one of the pair of side walls 62. The basal end portion 64 has the dimension L1 with respect to the first direction and the dimension L1 is greater than the dimension L2 of the electric wire housing portion 60 with respect to the second direction.

According to such a configuration, with the basal end portion 64 being long in the first direction, the electric wire 45 can be surely held by the stopper piece 63.

In the embodiment, the largest dimension L3 of the stopper piece 63 measured in the second direction is greater than a half of the dimension L2 of the electric wire housing portion 60 measured in the second direction.

According to such a configuration, with the stopper piece 63 being long in the second direction, the electric wire 45 can be held by the stopper piece 63 more surely.

In the embodiment, the dimension of the stopper piece 63 with respect to the first direction decreases as the stopper piece 63 extends from the basal end portion 64 toward the distal end portion 65.

According to such a configuration, the electric wire 45 can be easily arranged in the electric wire housing portion 60.

In the embodiment, the smallest dimension L4 between the distal end portion 65 and the other one of the pair of side walls 62 is smaller than the outer diameter D1 of the electric wire 45.

According to such a configuration, the electric wire 45 is less likely to be out of the electric wire housing portion 60.

In the embodiment, the other one of the pair of side walls 62 includes the opposing portion 66 that is opposite the distal end portion 65 and the recess portion 67 that is recessed toward the bottom wall 61 from the opposing portion 66.

According to such a configuration, with the recess portion 67, the electric wire 45 can be easily arranged in the electric wire housing portion 60.

In the embodiment, the electric wire housing portion 60 includes the stopper pieces 63, the pair of side walls 62 include the first side wall 62A and the second side wall 62B, and the stopper pieces 63 include the first stopper piece 63A extending from the first side wall 62A and the second stopper piece 63B extending from the second side wall 62B.

According to such a configuration, with the first stopper piece 63A extending from the first side wall 62A and the second stopper piece 63B extending from the second side wall 62B being provided, the electric wire 45 is further less likely to be out of the electric wire housing portion 60.

In the embodiment, the first stopper pieces 63A and the second stopper pieces 63B are arranged alternately in the first direction.

According to such a configuration, the first stopper pieces 63A and the second stopper pieces 63B are arranged alternately. Therefore, the electric wire 45 is further less likely to be out of the electric wire housing portion 60.

### Other Embodiments

(1) In the above embodiment, the stopper piece 63 has a substantially isosceles triangle shape seen from the opening side of the electric wire housing portion 60; however, it is not limited thereto. The shape of the stopper piece seen from the opening side of the electric wire housing portion may be triangular shapes other than the isosceles triangle, a square shape, a semicircular shape, and a semi-ellipse shape.
(2) In the above embodiment, the electric wire housing portion 60 opens frontward; however, the electric wire housing portion may open in any directions.
(3) In the above embodiment, the electric wire housing portion 60 is configured to receive multiple electric wires 45; however, the electric wire housing portion may be configured to receive one electric wire. For instance, the branch routing portion may be configured similar to the electric wire housing portion.
(4) In the above embodiment, the electric wire 45 arranged in the electric wire housing portion 60 is a voltage detection wire; however, the electric wire arranged in the electric housing portion may be an electric wire that is to be connected to a thermistor for measuring a temperature of a power storage element.

### EXPLANATION OF SYMBOLS

10: Power storage module
11: Laminated type battery
11L: Battery stuck member
12: Electrode lead
12A: Connection electrode lead
12B: Output electrode lead
13: Connection portion
14: Output portion
20: Wiring module
30: Terminal
31: Body portion
32: Connection portion
34: Wire connection portion
40: Busbar
40A: First portion
40B: Second portion
41: Busbar side connection portion
45: Electric wire
50: Protector
51: Protector body
52: Electrode housing recess portion
52A: Connection electrode housing recess portion
52B: Output electrode housing recess portion
53: Busbar holding portion
53A: Bolt fixing portion
54: Terminal housing portion
55: Branch routing portion
55A: Groove bottom wall
55B: Groove side wall
55C: Stopper protrusion
60: Electric wire housing portion
61: Bottom wall
62: Side wall
62A: First side wall
62B: Second side wall
63: Stopper piece
63A: First stopper piece
63B: Second stopper piece
64: Basal end portion
65: Distal end portion
66: Opposing portion
67: Recess portion
68: Connection portion
D1: Outer diameter of the electric wire
L1: Dimension of the basal end portion in a right-left direction
L2: Dimension of the electric wire housing portion in an upper-bottom direction
L3: Largest dimension of the stopper piece in the upper-bottom direction
L4: Dimension between the distal end portion and the opposing portion

1. A wiring module to be coupled to a battery stack member including power storage elements that have electrode terminals and are stacked, the wiring module comprising:
an electric wire; and
a protector including an electric wire housing portion that has a groove shape extending in a first direction and in which the electric wire is arranged, wherein
the electric wire housing portion includes
a bottom wall,
a pair of side walls that extend upward from two side edges of the bottom wall and that are opposite each other in a second direction that is perpendicular to the first direction, and
at least one stopper piece that extends from one of the pair of side walls toward other one of the pair of side walls and with which the electric wire is less likely to be out of the electric wire housing portion,
the stopper piece includes a basal end portion that is connected to the one of the pair of side walls and a distal end portion that is close to the other one of the pair of side walls, and
a dimension of the basal end portion with respect to the first direction is greater than a dimension of the electric wire housing portion with respect to the second direction.

2. The wiring module according to claim 1, wherein a largest dimension of the stopper piece with respect to the second direction is greater than a half of the dimension of the electric wire housing portion with respect to the second direction.

3. The wiring module according to claim 1, wherein a dimension of the stopper piece with respect to the first direction decreases as the stopper piece extends from the basal end portion toward the distal end portion.

4. The wiring module according to claim 1, wherein a smallest dimension of a space between the distal end portion and the other one of the pair of side walls is smaller than an outer diameter of the electric wire.

5. The wiring module according to claim 1, wherein the other one of the pair of side walls includes an opposing portion that is opposite the distal end portion and a recess portion that is recessed from the opposing portion toward the bottom wall.

6. The wiring module according to claim 1, wherein
the electric wire housing portion includes stopper pieces including the at least one stopper piece,
the pair of side walls include a first side wall and a second side wall, and
the stopper pieces include first stopper pieces extending from the first side wall and second stopper pieces extending from the second side wall.

7. The wiring module according to claim 6, wherein the first stopper pieces and the second stopper pieces are arranged alternately in the first direction.
